(19) United States
(12) Patent Application Publication
(10) Pub. No.: US 2007/0261727 A1
(43) Pub. Date: Nov. 15, 2007

(54) Knife cleaning device

(75) Inventors: Tzu Lung Ho, Fenyuan (TW); Kuan Yu Chen, Fenyuan (TW)

Correspondence Address: CHARLES E. BAXLEY, ESQ., 90 JOHN STREET, THIRD FLOOR, NEW YORK, NY, 10038, US

(73) Assignee: Min Shin Machinery Co., Ltd.

(21) Appl. No.: 11/430,667

(22) Filed: May 9, 2006

(51) Int. Cl. B08B 3/12

(52) U.S. Cl. 134/184

(57) ABSTRACT

A knife cleaning device includes a container having a chamber for receiving an ultrasonic wave transmitting medium, a supporting casing attached into the container and having one or more slots for receiving one or more knives to be cleaned, and an ultrasonic generating device attached to the container for generating ultrasonic waves to clean the knives, such as the steak knives having grease materials attached onto the wavy or serrated surfaces of the knives. One or more further supporting casings may be changeably attached into the upper portion of the container and includes one or more slots for receiving different knives to be cleaned.

### BACKGROUND OF THE INVENTION

1. Field of the Invention

The present invention relates to a knife cleaning device, and more particularly to a knife cleaning device including an ultrasonic generating device for cleaning knives, such as the steak knives, and for suitably cleaning or removing the greasy materials from the steak knives.

2. Description of the Prior Art

Typically, after using or operation, the knives, such as the surgical knives, the cautery knives, the kitchen knives may have to be cleaned or washed for further use, and for preventing objects or people from being contaminated, such that various kinds of knife cleaning devices have been developed and provided for cleaning or washing the knives.

For example, U.S. Pat. No. 4,547,923 to DeVries et al. discloses one of the typical knife cleaning devices or knife cleaners comprising a closely coiled strand rotatably supported on a base and disposed on an axis parallel to the base, and the knife blades or cutting edges may be engaged into the closely coiled strand in the direction transverse to the axis of the coil in order to clean the cutting edges of the knives.

For some of the knives, such as the steak knives, one or more wavy surfaces or serrated surfaces or the like may be formed or provided on either or both sides of the knives for facilitating the cutting operation of the knives. However, the dirt or grease materials or the contaminants engaged in the wavy surfaces or serrated surfaces of the knives may not be suitably cleaned by the closely coiled strand.

U.S. Pat. No. 5,652,993 to Kreyer discloses another typical knife cleaning device or knife cleaner comprising a pair of facing brushes mounted to a plate on opposite sides of a central opening, for engaging with and for cleaning opposed faces of the knives. However, similarly, the grease materials or the contaminants engaged in the wavy surfaces or serrated surfaces of the knives may not be suitably cleaned by the closely coiled strand.

The present invention has arisen to mitigate and/or obviate the afore-described disadvantages of the conventional knife cleaning devices.

### SUMMARY OF THE INVENTION

The primary objective of the present invention is to provide a knife cleaning device including an ultrasonic generating device for cleaning knives, such as the steak knives, and for suitably cleaning or removing the greasy materials from the steak knives.

The other objective of the present invention is to provide a knife cleaning device including one or more further supporting casings changeably attached into the upper portion of an outer container and having one or more slots of different shapes or sizes or areas or depths or widths for receiving different knives to be cleaned.

In accordance with one aspect of the invention, there is provided a knife cleaning device comprising a container including a chamber formed therein for receiving an ultrasonic wave transmitting medium therein, and including an upper portion, a supporting casing attached into the upper portion of the container and including at least one slot formed therein for receiving a knife to be cleaned, and an ultrasonic generating device attached to the container for generating ultrasonic waves to suitably clean and remove the dirt or the grease materials or the contaminant from the knife.

The container includes a compartment formed therein and defined by a partition for receiving the ultrasonic generating device. The container includes an outlet port formed therein and communicating with the chamber of the container for discharging the ultrasonic wave transmitting medium.

The container includes a peripheral flange extended inwardly from the upper portion of the container and extended into the chamber of the container for forming an opening in the upper portion of the container and for receiving or supporting the supporting casing.

The container includes a peripheral recess formed in the peripheral flange, and the supporting casing includes a peripheral flap extended outwardly therefrom for engaging onto the peripheral flange and for supporting the supporting casing on the upper portion of the container.

A securing frame may further be provided and disposed and engaged onto the peripheral flap of the supporting casing and secured to the upper portion of the container with at least one fastener. The container includes at least one switch button disposed thereon for controlling the ultrasonic generating device, and a timer for controlling an operating time of the ultrasonic generating device.

One or more further supporting casings may further be provided and changeably attached into the upper portion of the container and includes one or more slots formed therein for receiving different knives to be cleaned.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a knife cleaning device in accordance with the present invention;

FIG. 2 is a perspective view of the knife cleaning device;

FIG. 3 is a cross sectional view of the knife cleaning device, taken along lines 3-3 of FIG. 2;

FIG. 4 is a partial exploded view illustrating the changing operation of the knife supporting member for the knife cleaning device;

FIG. 5 is a perspective view similar to FIG. 2, illustrating the operation of the knife cleaning device; and

FIG. 6 is a cross sectional view of the knife cleaning device, taken along lines 6-6 of FIG. 5.

### DETAILED DESCRIPTION OF THE PREFERRED EMBODIMENT

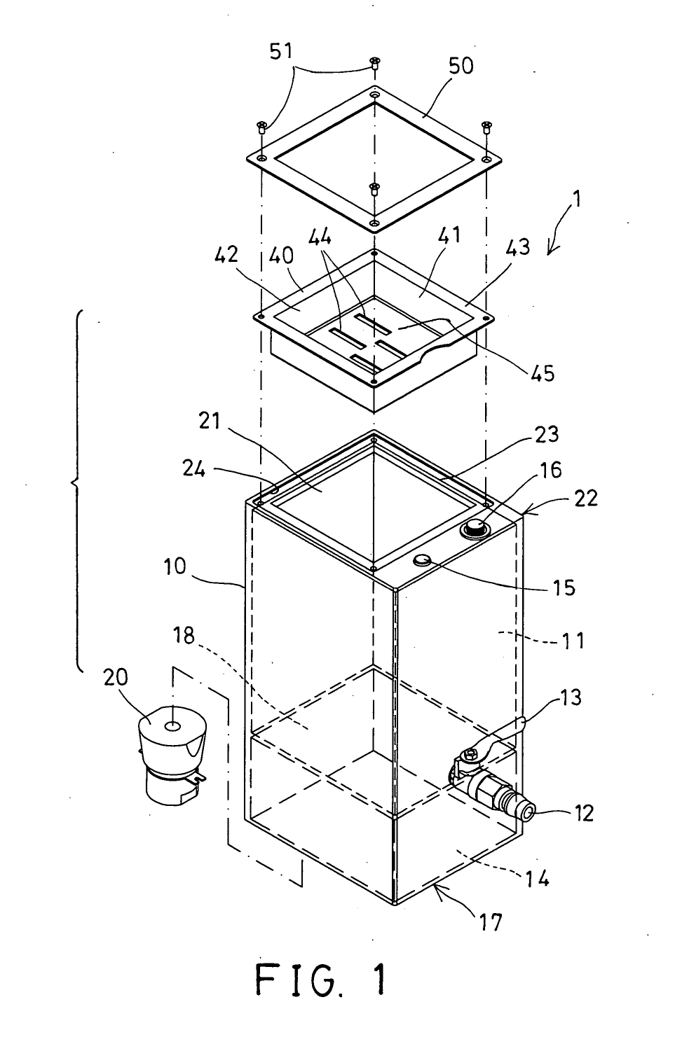

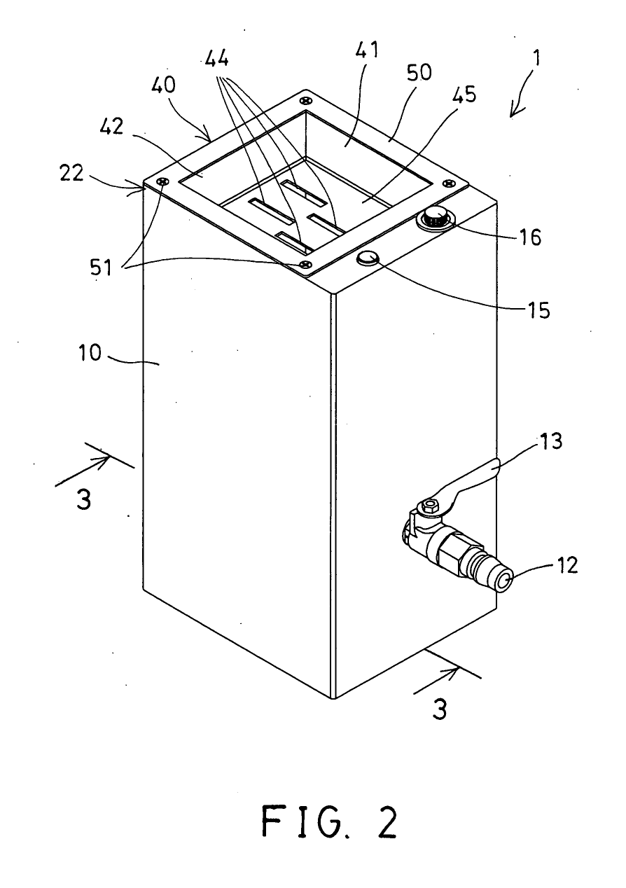

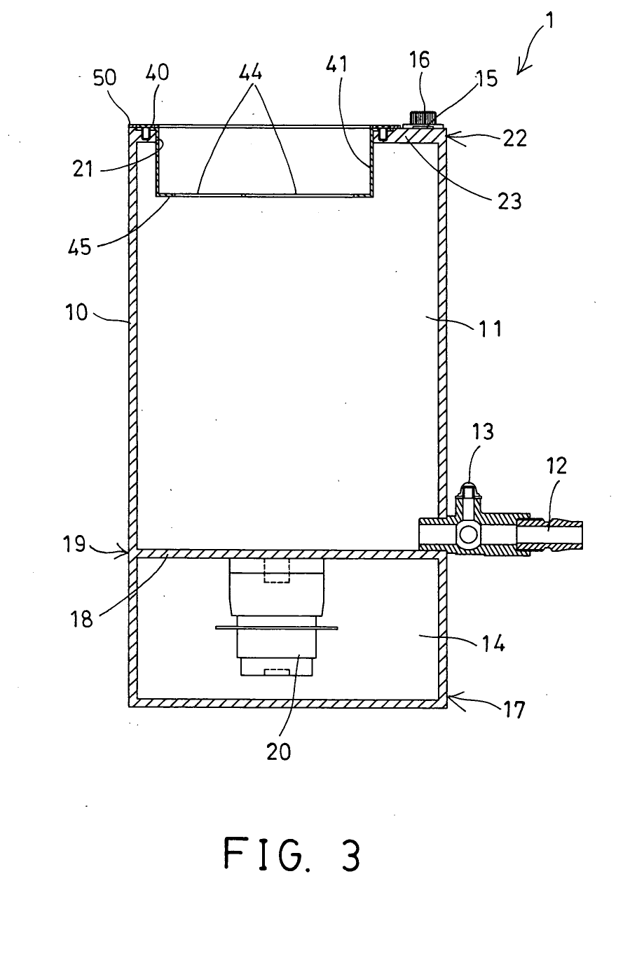

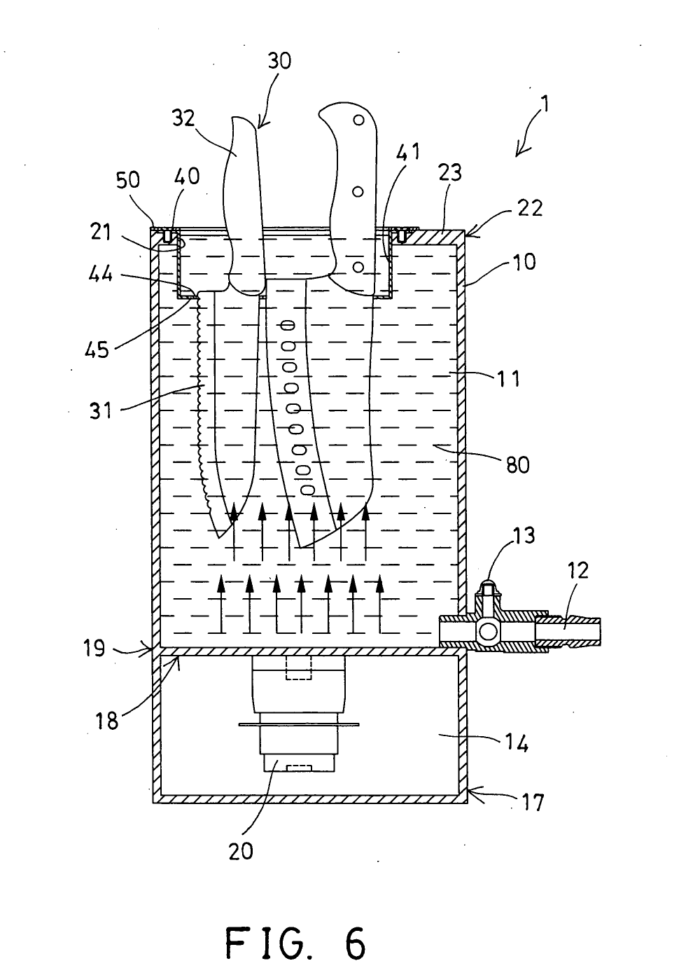

Referring to the drawings, and initially to FIGS. 1-3, a knife cleaning device 1 in accordance with the present invention comprises a housing or container 10 including a chamber 11 formed therein for receiving an ultrasonic wave transmitting medium 80 (FIG. 6), such as water therein, and including an outlet port 12 formed or provided in the lower or middle portion 19 thereof and communicating with the chamber 11 thereof for allowing the ultrasonic wave transmitting medium 80 to flow out or to be discharged from the container 10. A control valve 13 may be attached or coupled to the outlet port 12 for controlling the ultrasonic wave transmitting medium 80 to flow out through the outlet port 12 of the container 10.

It is preferable that the container 10 includes a compartment 14 formed or provided in the lower portion 17 thereof, and includes a partition 18 disposed or provided in the middle portion 19 thereof for forming the compartment 14 and/or for separating the compartment 14 and the chamber 11 of the container 10 from each other. An ultrasonic generating device 20 may be disposed or attached or received in the compartment 14 of the container 10 for generating ultrasonic waves and/or for generating air bubbles to clean the knives 30, such as the steak knives 30, and for suitably cleaning or removing the dirt or greasy materials from the steak knives 30.

One or more switches or switch buttons 15 may be provided on the upper portion of the container 10 for controlling or operating the ultrasonic generating device 20, and one or more timers 16 may further be provided on the upper portion of the container 10 for controlling or setting the operating time of the ultrasonic generating device 20. For example, when the knives 30 include much more dirt or greasy materials attached onto the knives 30, it may take a longer time to energize or to operate the ultrasonic generating device 20 in order to suitably remove the dirt or the greasy materials from the steak knives 30.

The container 10 further includes an opening 21 formed or provided in the upper portion 22 thereof and communicating with the chamber 11 thereof, and includes a peripheral flange 23 extended inwardly from the upper portion 22 of the container 10 and extended into the chamber 11 thereof for forming or defining the opening 21 of the container 10. One or more supporting trays or cups or baskets or casings 40 may further be provided and changeably disposed into the upper portion 22 or the upper opening 21 of the container 10, and each include a space 41 formed therein and defined by a peripheral wall 42, and includes a peripheral flap 43 extended outwardly from the upper portion of the supporting casing 40 for engaging onto the peripheral flange 23 and thus for supporting the supporting casing 40 on the upper portion of the container 10.

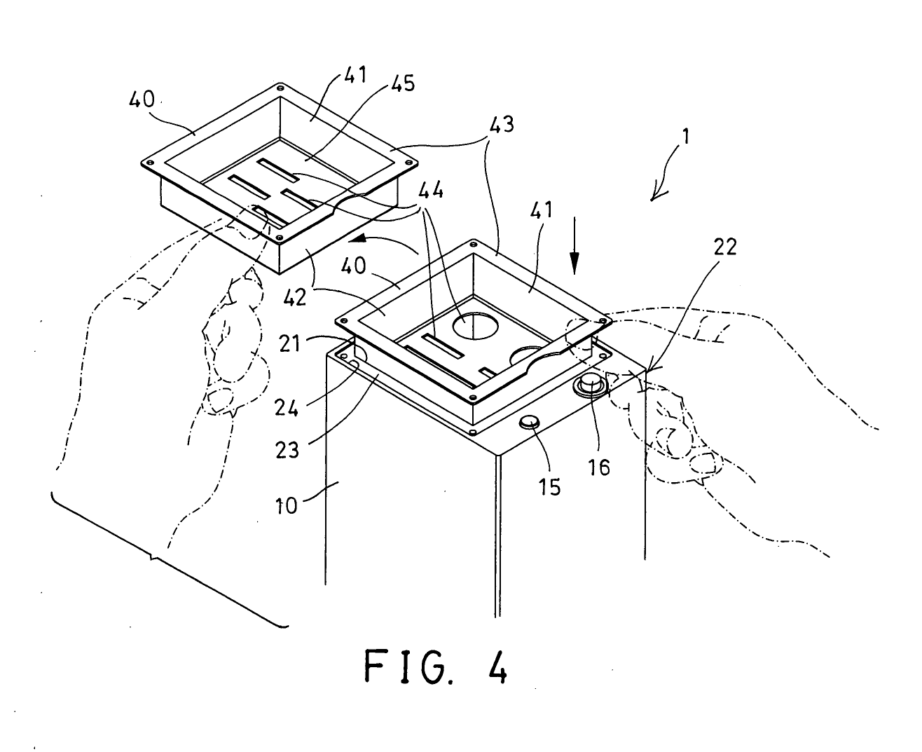

It is further preferable that the container 10 includes a peripheral shoulder or peripheral recess 24 (FIGS. 1, 4) formed or provided in the upper portion 22 thereof, and preferably formed in the peripheral flange 23 for stably positioning or anchoring the supporting casing 40 on the upper portion of the container 10. A securing frame 50 may further be provided and disposed or engaged onto the peripheral flap 43 of the supporting casing 40 and for stably or solidly securing the supporting casing 40 on or in the upper portion of the container 10 with such as one or more fasteners 51.

The supporting casings 40 each include one or more slots 44 formed therein, such as formed in a bottom board 45 of the supporting casing 40 for receiving the knife blades 31 of the knives 30 (FIG. 6) and for allowing the knife blades 31 of the knives 30 to be engaged into the chamber 11 of the container 10 and/or to be engaged into the ultrasonic wave transmitting medium 80 that is received or contained in the chamber 11 of the container 10, and thus for allowing the knife blades 31 of the knives 30 to be suitably cleaned by the ultrasonic waves and/or the air bubbles that are generated by the ultrasonic generating device 20.

It is further preferable that the slots 44 of the supporting casing 40 includes a size or area or width or depth greater than that of the knife blades 31 of the knives 30 for allowing the knife blades 31 of the knives 30 to be engaged through the slots 44 of the supporting casing 40 and engaged into the chamber 11 of the container 10 and/or engaged into the ultrasonic wave transmitting medium 80. The slots 44 of the supporting casing 40 includes a size or area or width or depth smaller than that of the handles 32 of the knives 30 for allowing the handles 32 of the knives 30 to be anchored and supported in the space 41 of the supporting casing 40 and for preventing the knives 30 from being completely engaged into the chamber 11 of the container 10. The shapes of the slots 44 of the supporting casing 40 may be different from each other for receiving and supporting knives 30 of different shapes.

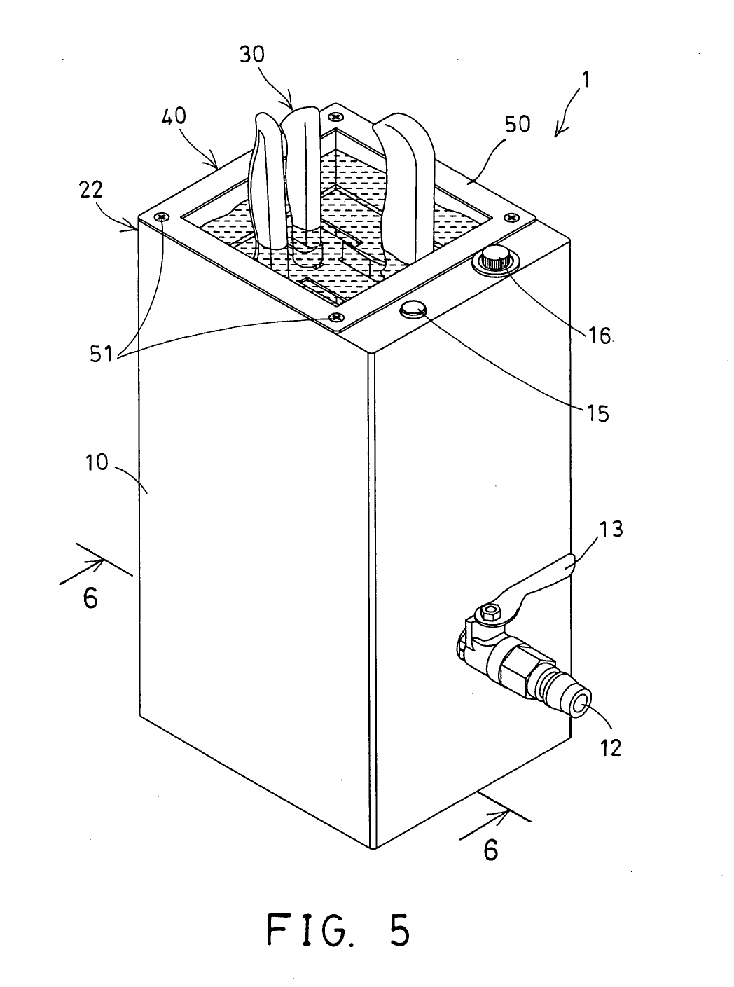

In operation, as shown in FIGS. 5 and 6, the ultrasonic wave transmitting medium 80 that is received or contained in the chamber 11 of the container 10 may also flow into the space 41 of the supporting casing 40 via the slots 44 of the supporting casing 40 for allowing the handles 32 of the knives 30 to be partially or completely engaged into the ultrasonic wave transmitting medium 80 that flows into the space 41 of the supporting casing 40, and thus for allowing the dirt and/or the greasy materials to be suitably cleaned or removed from the knife blades 31 and/or the handles 32 of the knives 30.

Accordingly, the knife cleaning device in accordance with the present invention includes an ultrasonic generating device for cleaning knives, such as the steak knives, and for suitably cleaning or removing the greasy materials from the steak knives.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A knife cleaning device comprising:
a container including a chamber formed therein for receiving an ultrasonic wave transmitting medium therein, and including an upper portion,
a supporting casing attached into said upper portion of said container and including at least one slot formed therein for receiving a knife to be cleaned, and
an ultrasonic generating device attached to said container for generating ultrasonic waves to clean the knife.

2. The knife cleaning device as claimed in claim 1, wherein said container includes a compartment formed therein and defined by a partition for receiving said ultrasonic generating device.

3. The knife cleaning device as claimed in claim 1, wherein said container includes an outlet port formed therein and communicating with said chamber of said container for discharging the ultrasonic wave transmitting medium.

4. The knife cleaning device as claimed in claim 1, wherein said container includes a peripheral flange extended inwardly from said upper portion of said container and extended into said chamber of said container for forming an opening in said upper portion of said container and for receiving said supporting casing.

5. The knife cleaning device as claimed in claim 4, wherein said container includes a peripheral recess formed in said peripheral flange, and said supporting casing includes a peripheral flap extended outwardly therefrom for engaging onto said peripheral flange and for supporting said supporting casing on said upper portion of said container.

6. The knife cleaning device as claimed in claim 5, wherein a securing frame is disposed and engaged onto said peripheral flap of said supporting casing and secured to said upper portion of said container with at least one fastener.

7. The knife cleaning device as claimed in claim 1, wherein said container includes at least one switch button disposed thereon for controlling said ultrasonic generating device.

8. The knife cleaning device as claimed in claim 1, wherein said container includes a timer disposed thereon for controlling an operating time of said ultrasonic generating device.

9. The knife cleaning device as claimed in claim 1, wherein at least one supporting casing is changeably attached into said upper portion of said container and includes at least one slot formed therein for receiving a different knife to be cleaned.
